(19) United States
(12) Patent Application Publication
(10) Pub. No.: US 2024/0253516 A1
(43) Pub. Date: Aug. 1, 2024

(54) METHOD FOR REPLACING BATTERY

(71) Applicant: TOYOTA JIDOSHA KABUSHIKI KAISHA, Toyota-shi (JP)

(72) Inventor: Shintaro IWAASA, Nagoya-shi (JP)

(73) Assignee: TOYOTA JIDOSHA KABUSHIKI KAISHA, Toyota-shi (JP)

(21) Appl. No.: 18/490,201

(22) Filed: Oct. 19, 2023

(30) Foreign Application Priority Data
Jan. 27, 2023 (JP) 2023-010729

(51) Int. Cl. B60L 53/80; B60S 5/06; G06F 8/654

(52) U.S. Cl. CPC B60L 53/80; B60S 5/06; G06F 8/654

(57) ABSTRACT

A method for replacing a battery includes steps of removing an old battery unit including an old battery and an old memory from a battery support portion of a vehicle, attaching a new battery unit including a new battery and a new memory to the battery support portion, and writing the update program for the vehicle into the new memory before attaching the unit to the battery support.

### CROSS-REFERENCE TO RELATED APPLICATION

This application claims priority to Japanese Patent Application No. 2023-010729 filed on Jan. 27, 2023, incorporated herein by reference in its entirety.

### BACKGROUND

### 1. Technical Field

The present disclosure relates to a technology for replacing a battery of a vehicle.

### 2. Description of Related Art

Japanese Unexamined Patent Application Publication No. 2020-040613 (JP 2020-040613 A) discloses a technology for updating software (program) of a vehicle. In this related art, a program stored in a computer of the vehicle is updated by handshake communication while an external computer storing update software (program) and the computer of the vehicle are connected in parallel.

When updating the program of the vehicle, an update program is acquired from a server via a communication device mounted on the vehicle. In this case, the vehicle may need to bear a large amount of communication costs depending on the size of the update program and the update frequency.

Consideration is made about vehicle-related facilities such as gasoline stations and charging stations that are scattered in each region. When a device storing the update program is installed in the vehicle-related facility, the program of the vehicle can be updated by wired connection or short-range communication between this device and the computer of the vehicle. With this method, the communication costs can be avoided. In this method, however, the vehicle cannot leave the vehicle-related facility until the reception of the program is completed. Depending on the size of the update program, the waiting period at the vehicle-related facility may increase.

### SUMMARY

One object of the present disclosure is to provide a technology that can reduce a load on a vehicle for update of a program of the vehicle.

The inventors have found that the above problem can be solved by updating a program of a vehicle in combination with replacement of a battery of the vehicle in a vehicle-related facility. Accordingly, aspects of the present disclosure relate to a method for replacing a battery mounted on a vehicle.

In a first aspect of the present disclosure, the method includes:
a step of removing an old battery unit including an old battery and an old memory from a battery support of the vehicle;
a step of attaching a new battery unit including a new battery and a new memory to the battery support; and
a step of writing an update program associated with the vehicle into the new memory before attaching the new battery unit to the battery support.

A second aspect of the present disclosure further has the following feature in addition to those in the first aspect.

The step of writing the update program into the new memory may be performed before removing the old battery unit from the battery support.

A third aspect of the present disclosure further has the following feature in addition to those in the first or second aspect.

The method may further include a step of requesting update of an in-vehicle program by the vehicle.
The update program may be a program for updating a part of the in-vehicle program.

A fourth aspect of the present disclosure further has the following feature in addition to those in the first or second aspect.

The old memory may store identification information of the vehicle.
The step of writing the update program into the new memory may include:
a step of comparing the identification information of the vehicle with a list of vehicles scheduled for program update; and
a step of selecting the update program associated with the vehicle based on a result of comparing the identification information of the vehicle with the list of vehicles scheduled for program update.

A fifth aspect of the present disclosure further has the following feature in addition to those in the first or second aspect.

The vehicle is a battery-replaceable electrified vehicle.

According to the present disclosure, when replacing the battery unit of the vehicle, the update program associated with the vehicle is written into the new memory before the new battery unit is attached to the battery support. When replacing the battery unit, the vehicle need not bear communication costs for the program update. Since the update program has already been written into the new memory, the vehicle need not wait at the vehicle-related facility until the reception of the update program is completed. Therefore, it is possible to reduce the load on the vehicle for the update of the program of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram for explaining an overview of a method for replacing a battery according to Embodiment1;

FIG. 1B is a diagram for explaining an overview of a method for replacing a battery according to Embodiment 1;

FIG. 1C is a diagram for explaining an outline of a method for replacing a battery according to Embodiment 1;

FIG. 2 is a diagram for explaining a specific example of the first example of the method for replacing a battery according to Embodiment 1;

FIG. 3 is a diagram for explaining a specific example of the second example of the method for replacing a battery according to Embodiment 1;

FIG. 4A is a flowchart showing a processing example of a method for replacing a battery according to Embodiment 1;

FIG. 4B is a flowchart showing a processing example of the method for replacing a battery according to Embodiment 1;

FIG. 5 is a diagram for explaining a specific example of a method for replacing a battery according to Embodiment 2;

FIG. 6A is a flowchart showing a processing example of a method for replacing a battery according to Embodiment 2; and

FIG. 6B is a flowchart illustrating a processing example of the method for replacing a battery according to the second embodiment.

### DETAILED DESCRIPTION OF EMBODIMENTS

A method for replacing a battery according to an embodiment of the present disclosure will be described with reference to the accompanying drawings. Elements common to each drawing are assigned the same reference numerals, and overlapping descriptions are omitted.

### 1. EMBODIMENT 1

### 1-1. Outline

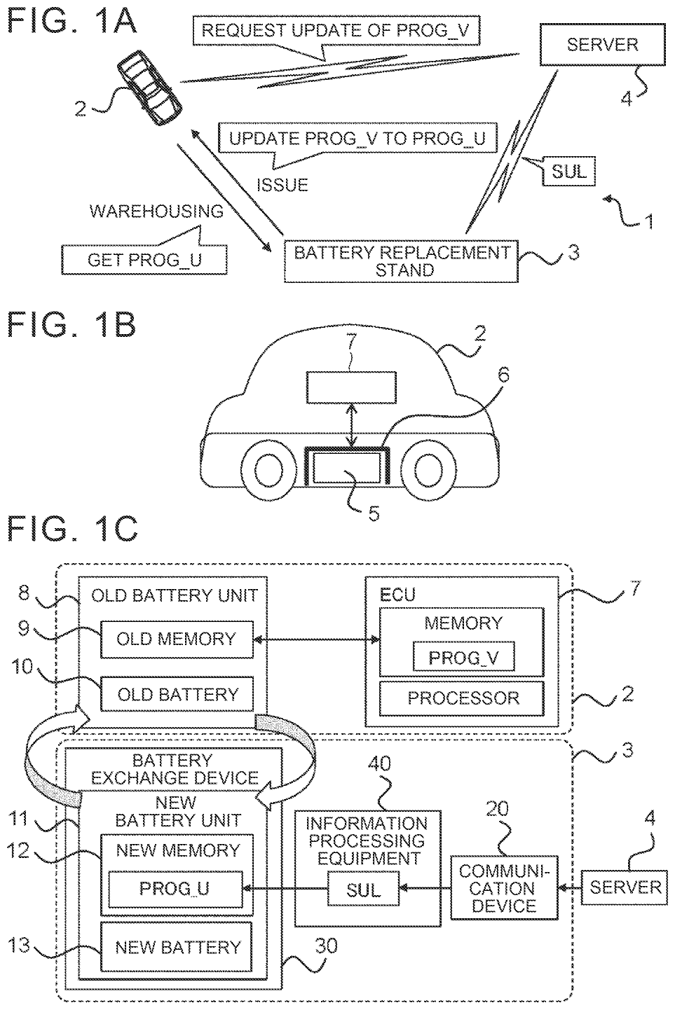

FIG. 1A is a diagram for explaining an outline of a battery exchange system 1 for realizing Embodiment 1. As shown in FIG. 1A, battery exchange system 1 includes vehicle 2, battery replacement stand 3, and server 4. The vehicle 2 is, for example, a vehicle that uses a secondary battery such as a lithium ion battery as a drive source. A hybrid electric vehicle (HEV), a plug-in hybrid electric vehicle (PHEV), and a battery electric vehicle (BHV) are exemplified as vehicles using a secondary battery as a drive source. The vehicle 2 may be a vehicle that operates automatically or a vehicle that operates manually.

In Embodiment 1, it is assumed that the battery of vehicle 2 can be replaced at battery replacement stand 3. For example, when the remaining amount of the battery of the vehicle 2 drops to a certain amount, the battery of the vehicle 2 is replaced with a new one. The battery replacement stand 3 and server 4 provide such a battery exchange service. In the battery replacement service, based on a replacement request from the vehicle 2, the location and time of the battery replacement stand 3 where the battery is replaced are set. This setting may be made by the driver of the vehicle 2 accepting a replacement proposal from the server 4.

Aside from the battery replacement request, the vehicle 2 requests the server 4 to update the in-vehicle program PROG_V. When the server 4 receives a request to update the in-vehicle program PROG_V from the vehicle 2, the server 4 generates a program update scheduled vehicle list SUL. Then, the server 4 transmits the program update scheduled vehicle list SUL to the battery replacement stand 3. The program update scheduled vehicle list SUL includes data of the update program PROG_U scheduled to be installed in the vehicle 2. The update program PROG_U is, for example, a program that updates part of the in-vehicle program PROG_V.

The request for updating the in-vehicle program PROG_V to the server 4 may be made not by the vehicle 2 but by the manufacturer of the vehicle 2.

The battery replacement stand 3 incorporates the update program PROG_U corresponding to the vehicle 2 into the vehicle 2 based on the vehicle list SUL scheduled for program update received from the server 4. Specifically, when the vehicle 2 enters the battery replacement stand 3 only for the purpose of exchanging the battery of the vehicle 2 or updating the program, the battery replacement stand 3 replaces the battery mounted on the vehicle 2 with a new battery. Exchange. At the time of battery replacement, the battery replacement stand 3 writes the update program PROG_U corresponding to the vehicle 2 to the new battery.

Accordingly, when the vehicle 2 enters the battery replacement stand 3, the vehicle 2 can obtain the update program PROG_U corresponding to the vehicle 2. After the vehicle 2 leaves the battery replacement stand 3, the vehicle 2 updates the obtained update program PROG_U. The update program PROG_U is updated, for example, while the vehicle 2 is running.

FIG. 1B is a diagram for explaining the outline of the vehicle 2. Specifically, the vehicle 2 includes a battery unit 5, a battery support portion 6, and an ECU 7. Battery unit 5 includes a battery and a memory. The memory mounted on the battery unit 5 has a memory area in which the update program PROG_U can be written.

The battery support portion 6 has a structure that allows the battery unit 5 to be attached and detached. After the vehicle 2 enters the battery replacement stand 3, the battery support portion 6 removes the battery unit 5 and attaches another battery unit 5.

The ECU 7 includes a memory that stores an in-vehicle program PROG_V and a processor that executes the in-vehicle program PROG_V. Also, the ECU 7 is electrically connected to the battery unit 5 via the battery support portion 6.

FIG. 1C is a diagram for explaining an overview of the method of writing the update program PROG_U. Here, the battery unit 5 before replacement is referred to as an old battery unit 8. The battery unit 5 after replacement is called a new battery unit 11. In this case, the old battery unit 8 includes the old memory 9 and the old battery 10. A new battery unit 11 includes a new memory 12 and a new battery 13.

The battery replacement stand 3 includes a communication device 20, a battery exchange device 30 and an information processing device 40. The communication device 20 is a device that communicates with the server 4. The battery exchange device 30 is a device that removes the old battery unit 8 from the battery support portion 6 of the vehicle 2 and attaches the new battery unit 11 to the battery support portion 6 of the vehicle 2.

The information processing device 40 is a computer that executes processing for battery replacement of the vehicle 2. The information processing device 40 is connected to the server 4 via the communication device 20. The information processing device 40 is also connected to the battery exchange device 30.

The information processing device 40 executes various processes. The information processing device 40 also stores a battery replacement program. The method for replacing a battery according to the first embodiment is implemented by information processing device 40 executing the battery replacement program. Details of various processes executed by the information processing device 40 will be described later.

The information processing device 40 writes the update program PROG_U corresponding to the vehicle 2 into the new memory 12 based on the program update scheduled vehicle list SUL acquired from the server 4.

After the vehicle 2 enters the battery replacement stand 3, the information processing device 40 instructs the battery exchange device 30 to remove the old battery unit 8 from the battery support portion 6 of the vehicle 2. Further, the information processing device 40 instructs the battery exchange device 30 to attach the new battery unit 11 to the battery support portion 6 of the vehicle 2.

Here, the timing at which the information processing device 40 writes the update program PROG_U corresponding to the vehicle 2 into the new memory 12 will be considered. Since the battery of the vehicle 2 is replaced in units of the battery unit 5, the timing of writing the update program PROG_U corresponding to the vehicle 2 into the new memory 12 includes the following two patterns.

Specifically, the first pattern is to write the update program PROG_U to the new memory 12 after the new battery unit 11 is attached to the vehicle 2. Next, the second pattern is to write the update program PROG_U to the new memory 12 before installing the new battery unit 11 in the vehicle 2. In this case, the second pattern is more efficient than the first pattern. As an effect of this, for example, the waiting time at the battery replacement stand 3 can be shortened.

After the new battery unit 11 is attached to the vehicle 2, the ECU 7 reads the update program PROG_U stored in the new memory 12. Then, the ECU 7 rewrites part of the in-vehicle program PROG_V with the update program PROG_U.

Two specific examples of writing the update program PROG_U corresponding to the vehicle 2 into the new memory 12 will be described below.

### 1-2. Concrete Example

### 1-2-1. First Example

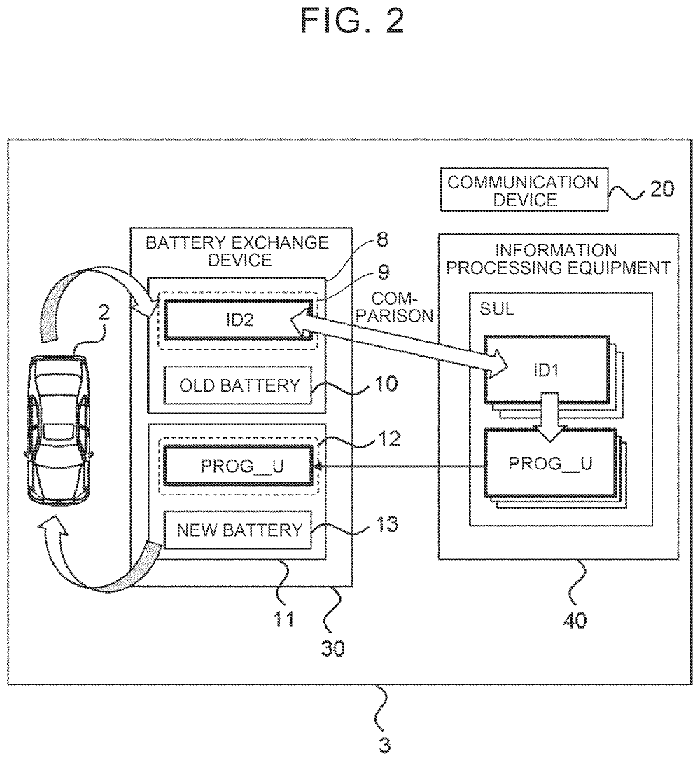

FIG. 2 is a diagram for explaining a specific example of the first example of the method for replacing a battery according to the first embodiment. In the specific example of the first example of the method for replacing a battery according to Embodiment 1, the update corresponding to the vehicle 2 is performed based on the information stored in the old battery unit 8 removed from the battery support portion 6 of the vehicle 2. Program PROG_U is written to new memory 12.

Specifically, as shown in FIG. 2, the program update scheduled vehicle list SUL includes vehicle identification information ID (hereinafter referred to as first vehicle identification information D1) and an update program PROG_U. The first vehicle identification information ID1 is obtained through the server 4 together with the update program PROG_U. Examples of the first vehicle identification information ID1 include vehicle type information, serial number information, version information of the in-vehicle program PROG_V, and the like.

The old memory 9 of the old battery unit 8 removed from the vehicle 2 stores at least vehicle identification information ID (hereinafter referred to as second vehicle identification information ID2). Examples of the second vehicle identification information ID2 include vehicle type information, serial number information, version information of the in-vehicle program PROG_V, and the like.

The information processing device 40 compares the first vehicle identification information ID1 and the second vehicle identification information ID2. Then, the information processing device 40 selects the update program PROG_U corresponding to the vehicle 2 based on the result of comparison between the first vehicle identification information ID1 and the second vehicle identification information ID2.

After that, the information processing device 40 writes the update program PROG_U corresponding to at least the vehicle 2 to the new memory 12. The information processing device 40 may write the version of the update program PROG_U to the new memory 12 together with the update program PROG_U.

### 1-2-2. Second Example

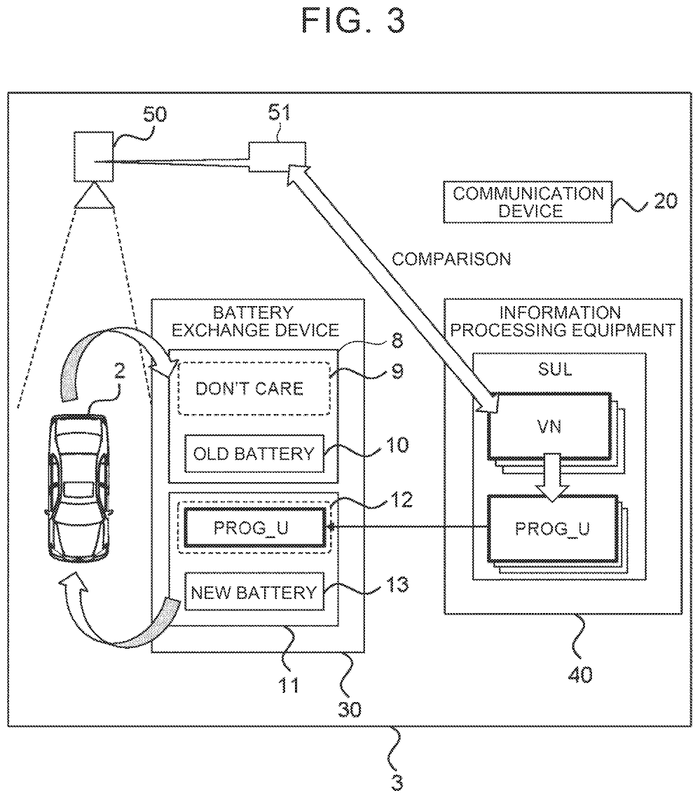

FIG. 3 is a diagram for explaining a specific example of the second example of the method for replacing a battery according to the first embodiment. In the specific example of the first example of the method for replacing a battery according to Embodiment 1, the vehicle 2 can be replaced without using the information stored in the old battery unit 8 removed from the battery support portion 6 of the vehicle 2. The updated program PROG_U is written in the new memory 12.

Specifically, as shown in FIG. 3, the battery replacement stand 3 includes an infrastructure camera 50. The infrastructure camera 50 is a sensor that takes an image of the license plate of the vehicle 2 when the vehicle 2 enters the battery replacement stand 3. The information processing device 40 acquires a camera image including the license plate of the vehicle 2 captured by the infrastructure camera 50. Then, the information processing device 40 recognizes the license plate number 51 of the vehicle 2 based on the camera image.

The information processing device 40 acquires the vehicle list SUL scheduled for program update via the server 4. The program update scheduled vehicle list SUL includes the vehicle number VN and the update program PROG_U.

The information processing device 40 compares the vehicle number VN and the license plate number 51 of the vehicle 2. Then, the information processing device 40 selects the update program PROG_U corresponding to the vehicle 2 based on the result of comparing the vehicle number VN and the license plate number 51 of the vehicle 2.

After that, the information processing device 40 writes the update program PROG_U corresponding to at least the vehicle 2 to the new memory 12. The information processing device 40 may write the version of the update program PROG_U to the new memory 12 together with the update program PROG_U.

### 1-2-3.Effect

As described above, in the method for replacing a battery according to the first embodiment, when replacing the battery unit of the vehicle 2, the new memory 12 of the update program PROG_U corresponding to the vehicle 2 is installed before the new battery unit 11 is attached to the battery support portion 6. When exchanging the battery unit, the vehicle 2 does not have to bear the communication cost for updating the program. In addition, since 12 of the update program PROG_U has already been written to the new memory, there is no need for the vehicle 2 to wait in the vehicle-related facility until the reception of the update program PROG_U is completed. Therefore, the load on the vehicle 2 for updating the program of the vehicle 2 can be reduced.

### 1-3. Processing Example

### 1-3-1. First Processing Example

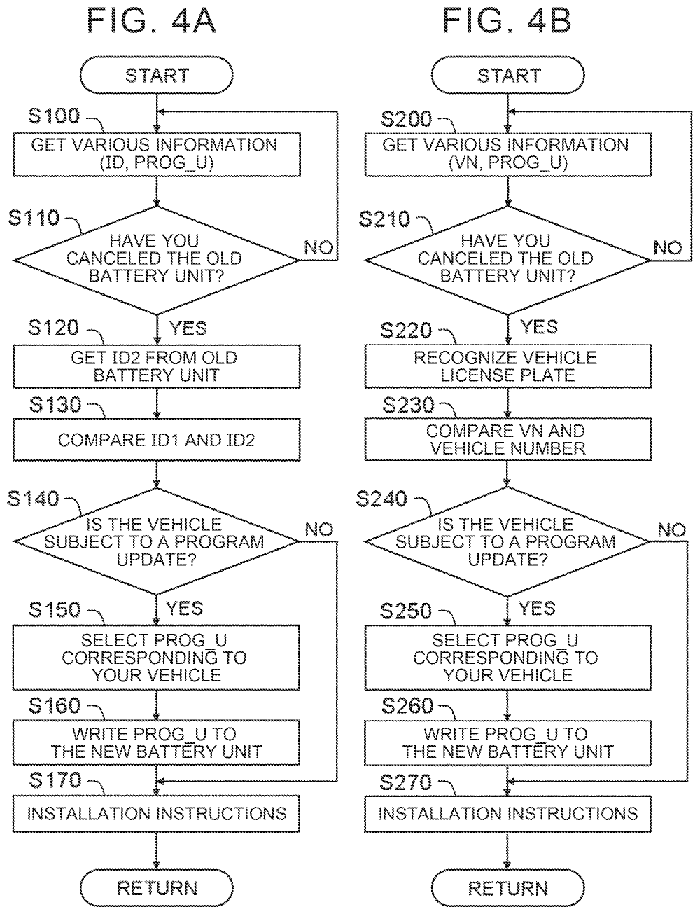

FIG. 4A is a flowchart showing a processing example of the first example of the information processing device 40.

In S100, the information processing device 40 acquires various kinds of information. After that, the process proceeds to S110. The various information includes first vehicle identification information ID1 and data of the update program PROG_U.

In S110, the information processing device 40 determines whether or not the old battery unit 8 has been removed. If it is determined that the old battery unit 8 has been removed (S110; Yes), the process proceeds to S120. Otherwise (S110; No), the process returns to S100.

At S120, the information processing device 40 acquires the second vehicle identification information ID2 from the old battery unit 8. After that, the process proceeds to S130.

In S130, the information processing device 40 compares the first vehicle identification information ID1 and the second vehicle identification information ID2. Thereafter, the process proceeds to S140. As a method of comparing the first vehicle identification information ID1 and the second vehicle identification information ID2, for example, it is determined whether the second vehicle identification information ID2 matching the first vehicle identification information ID1 is included.

In S140, the information processing device 40 compares the first vehicle identification information ID1 and the second vehicle identification information ID2, and determines whether the vehicle 2 is a program update scheduled target vehicle. If the vehicle 2 is determined to be a program update scheduled target vehicle (S140; Yes), the process proceeds to S150. Otherwise (S140; No), the process proceeds to S170.

In S150, the information processing device 40 selects the update program PROG_U corresponding to the vehicle 2. Thereafter, the process proceeds to S160.

In S160, the information processing device 40 writes the update program PROG_U to the new battery unit 11. Thereafter, the process proceeds to S170.

In S170, the information processing device 40 instructs the battery exchange device 30 to attach the new battery unit 11 to the battery support portion 6 of the vehicle 2.

### 1-3-2. Second Processing Example

FIG. 4B is a flowchart showing an example of processing of the second example of the information processing device 40. Here, processing different from the first processing example will be described, and description of processing that overlaps with the first processing example will be omitted. Specifically, S210, S250, S260, and S270, which overlap with the first processing example, respectively correspond to S110, S150, S160, and S170. Details of the processes of S200, S220, S230, and S240, which are different from the first process example, will be described below.

In S200, the information processing device 40 acquires various kinds of information. Thereafter, the process proceeds to S210. Various information includes vehicle number VN and update program PROG_U data.

In S220, the information processing device 40 recognizes the license plate number 51 of the vehicle 2 based on the camera image acquired by the infrastructure camera 50. After that, the process proceeds to S230.

In S230, the information processing device 40 compares the vehicle number VN and the license plate number 51 of the vehicle 2. After that, the process proceeds to S240. As a method of comparing the vehicle number VN and the license plate number 51 of the vehicle 2, for example, it is determined whether the license plate number 51 of the vehicle 2 matching the vehicle number VN is included.

In S240, the information processing device 40 compares the vehicle number VN with the license plate number 51 of the vehicle 2, and determines whether the vehicle 2 is a target vehicle scheduled for program update. If the vehicle 2 is determined to be the target vehicle for program update (S240; Yes), the process proceeds to S250. Otherwise (S240; No), the process proceeds to S270.

### 2. EMBODIMENT 2

In the method for replacing a battery according to the first embodiment described above, after the old battery unit 8 is removed from the battery support portion 6 and before the new battery unit 11 is attached to the battery support portion 6, an update corresponding to the vehicle 2 is performed. Program PROG_U is written to new memory 12. According to the method for replacing a battery according to the second embodiment, the update program PROG_U corresponding to the vehicle 2 is written into the new memory 12 before the old battery unit 8 is removed from the battery support portion 6.

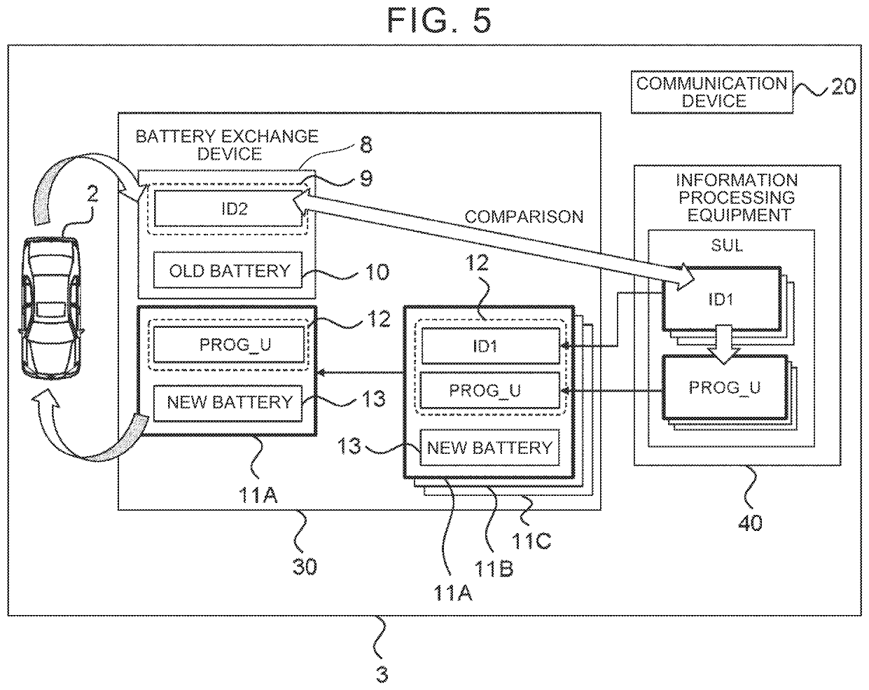

Specifically, as shown in FIG. 5, the information processing device 40 stores a vehicle list SUL whose program is scheduled to be updated. The program update scheduled vehicle list SUL includes the first vehicle identification information ID1 and the update program PROG_U, as in the first example of the method for replacing a battery according to the first embodiment.

Based on the program update scheduled vehicle list SUL, the information processing device 40 performs a process of writing the first vehicle identification information ID1, and the update program PROG_U corresponding to the first vehicle identification information ID1 into a new memory 12 of each of a plurality of new battery units 11 (11A, 11B, 11C).

The information processing device 40 compares the first vehicle identification information ID1 with the second vehicle identification information ID2 stored in the old memory 9 of the old battery unit 8 removed from the vehicle 2. Then, the information processing device 40 selects the new battery unit 11 in which the update program PROG_U corresponding to the vehicle 2 is stored based on the comparison result of the first vehicle identification information ID1 and the second vehicle identification information ID2. In the example shown in FIG. 5, the new battery unit 11A is selected as the new battery unit 11 in which the update program PROG_U corresponding to the vehicle 2 is stored.

As described above, in the method for replacing a battery according to the second embodiment, the update program PROG_U corresponding to the vehicle 2 is written into the new memory 12 before the old battery unit 8 is removed from the battery support portion 6. As a result, the same effect as the method for replacing a battery according to the first embodiment can be obtained. Furthermore, according to the method for replacing a battery according to the second embodiment, the new memory 12 storing the update program PROG_U is prepared before the vehicle 2 enters the battery replacement stand 3. Therefore, when the vehicle 2 enters the battery replacement stand 3, the new memory 12 storing the update program PROG_U is installed without checking the information stored in the old battery unit 8 removed from the battery support portion 6 of the vehicle 2. It can be attached to the battery support portion 6 of the vehicle 2. Therefore, the time required to obtain the update program PROG_U of the vehicle 2 can be shortened. It becomes possible to further reduce the burden on the vehicle 2 for updating the program of the vehicle 2.

Incidentally, in the method for replacing a battery according to the second embodiment, there are two method examples, a first example and a second example, similarly to the battery replacement method according to the first embodiment described above. Details of each processing example will be described below.

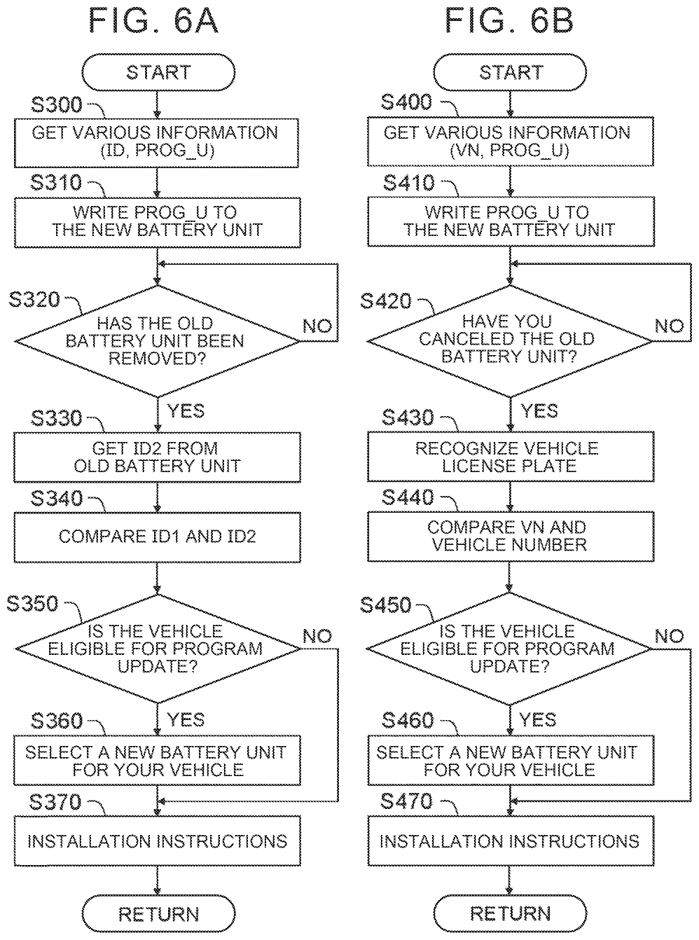

FIG. 6A is a flowchart showing a processing example of the first example of the information processing device 40.

In S300, the information processing device 40 acquires various kinds of information. After that, the process proceeds to S310. The various information includes first vehicle identification information ID1 and data of the update program PROG_U.

In S310, the information processing device 40 stores the first vehicle identification information ID1 and the first vehicle identification information ID1 in the new memory 12 of each of the plurality of new battery units 11 based on the program update scheduled vehicle list SUL. The process of writing the update program PROG_U is performed. The process then proceeds to S320.

In S320, the information processing device 40 determines whether or not the old battery unit 8 has been removed. If it is determined that the old battery unit 8 has been removed (S320; Yes), the process proceeds to S330. Otherwise (S320; No), the process returns to S320.

At S330, the information processing device 40 acquires the second vehicle identification information ID2 from the old battery unit 8. The process then proceeds to S340.

In S340, the information processing device 40 compares the first vehicle identification information ID1 and the second vehicle identification information ID2. The process then proceeds to S350.

In S350, the information processing device 40 compares the first vehicle identification information ID1 and the second vehicle identification information ID2, and determines whether the vehicle 2 is a program update scheduled target vehicle. If the vehicle 2 is determined to be a program update scheduled target vehicle (S350; Yes), the process proceeds to S360. Otherwise (S350; No), the process proceeds to S370.

In S360, the information processing device 40 selects the new battery unit 11 storing the update program PROG_U corresponding to the vehicle 2 from among the plurality of new battery units 11. The process then proceeds to S370.

In S370, the information processing device 40 instructs the battery exchange device 30 to attach the new battery unit 11 to the battery support portion 6 of the vehicle 2.

FIG. 6B is a flowchart showing a processing example of the second example of the information processing device 40. Here, processing different from the first processing example will be described. The description of the processing that overlaps with the first processing example is omitted. Specifically, S410, S420, S460, and S470 that overlap with the first processing example correspond to S310, S320, S360, and S370, respectively. Details of each of the processes of S400, S430, S440, and S450 that are different from the first process example will be described below.

In S400, the information processing device 40 acquires various types of information. Thereafter, the process proceeds to S410. Various information includes vehicle number VN and update program PROG_U data.

In S430, the information processing device 40 recognizes the license plate number 51 of the vehicle 2 based on the camera image acquired by the infrastructure camera 50. The process then proceeds to S440.

In S440, the information processing device 40 compares the vehicle number VN and the license plate number 51 of the vehicle 2. The process then proceeds to S450.

In S450, the information processing device 40 compares the vehicle number VN and the license plate number 51 of the vehicle 2, and determines whether the vehicle 2 is a target vehicle scheduled for program update. If the vehicle 2 is determined to be the target vehicle for program update (S450; Yes), the process proceeds to S460. Otherwise (S450; No), the process proceeds to S470.

What is claimed is:

1. A method for replacing a battery mounted on a vehicle, the method comprising:
a step of removing an old battery unit including an old battery and an old memory from a battery support of the vehicle;
a step of attaching a new battery unit including a new battery and a new memory to the battery support; and
a step of writing an update program associated with the vehicle into the new memory before attaching the new battery unit to the battery support.

2. The method according to claim 1, wherein the step of writing the update program into the new memory is performed before removing the old battery unit from the battery support.

3. The method according to claim 1, further comprising a step of requesting update of an in-vehicle program by the vehicle, wherein the update program is a program for updating a part of the in-vehicle program.

4. The method according to claim 1, wherein:
the old memory stores identification information of the vehicle; and
the step of writing the update program into the new memory includes
a step of comparing the identification information of the vehicle with a list of vehicles scheduled for program update, and
a step of selecting the update program associated with the vehicle based on a result of comparing the identification information of the vehicle with the list of vehicles scheduled for program update.

5. The method according to claim 1, wherein the vehicle is a battery-replaceable electrified vehicle.
